(19) United States
(12) Patent Application Publication
(10) Pub. No.: US 2023/0348131 A1
(43) Pub. Date: Nov. 2, 2023

(54) Carton With Article Retention Features

(71) Applicant: Graphic Packaging International, LLC, Atlanta, GA (US)

(72) Inventor: Meng-Chuan Wu, Norcross, GA (US)

(21) Appl. No.: 18/140,138

(22) Filed: Apr. 27, 2023

Related U.S. Application Data
(60) Provisional application No. 63/335,823, filed on Apr. 28, 2022.

(51) Int. Cl. B65D 5/50; B65D 5/02; B65D 5/54; B31B 50/26

(52) U.S. Cl. CPC B65D 5/5002; B65D 5/0227; B65D 5/54; B31B 50/262; B31B 2100/002

(57) ABSTRACT

A carton for holding one or more articles includes an outer portion having a first plurality of panels extending at least partially around a first interior of the carton, an article retention portion positioned in the first interior of the carton, the article retention portion having a second plurality of panels extending at least partially around a second interior of the carton for holding the one or more articles, the article retention portion separably connected to the outer portion, and a plurality of end flaps foldably connected to a respective panel of the first plurality of panels for forming at least one closed end of the carton.

### CROSS-REFERENCE TO RELATED APPLICATION

This application claims the benefit of U.S. Provisional Patent Application No. 63/335,823, filed on Apr. 28, 2022.

### INCORPORATION BY REFERENCE

The disclosures of each of U.S. Provisional Patent Application No. 63/335,823, filed on Apr. 28, 2022, and U.S. Design Patent Application No. 29/890,682, filed on Apr. 26, 2023, are hereby incorporated for all purposes as if set forth in their entireties.

### BACKGROUND

The present disclosure generally relates to cartons for holding one or more articles.

More specifically, the present disclosure relates to cartons for holding one or more articles and that include interior retention features for holding the one or more articles.

### SUMMARY

According to one aspect, the disclosure is generally directed to a carton for holding one or more articles, the carton comprising an outer portion comprising a first plurality of panels extending at least partially around a first interior of the carton an article retention portion positioned in the first interior of the carton, the article retention portion comprising a second plurality of panels extending at least partially around a second interior of the carton for holding the one or more articles, the article retention portion separably connected to the outer portion, and a plurality of end flaps foldably connected to a respective panel of the first plurality of panels for forming at least one closed end of the carton.

According to another aspect, the disclosure is generally directed to a blank for forming a carton for holding one or more articles, the blank comprising an outer portion comprising a first plurality of panels for extending at least partially around a first interior of the carton formed from the blank, an article retention portion for being positioned in the first interior of the carton formed from the blank, the article retention portion comprising a second plurality of panels for extending at least partially around a second interior of the carton formed from the blank for holding the one or more articles, the article retention portion separably connected to the outer portion, and a plurality of end flaps foldably connected to a respective panel of the first plurality of panels for forming at least one closed end of the carton formed from the blank.

According to another aspect, the disclosure is generally directed to a method of forming a carton for holding one or more articles, the method comprising obtaining a blank comprising an outer portion separably connected to an article retention portion, the outer portion comprising a first plurality of panels, the article retention portion comprising a second plurality of panels, and a plurality of end flaps foldably connected to a respective panel of the first plurality of panels. The method further comprises positioning the first plurality of panels extending at least partially around a first interior of the carton to form an outer portion of the carton, positioning the second plurality of panels extending at least partially around a second interior of the carton to form an article retention portion of the carton positioned in the first interior of the carton and separably connected to the outer portion of the carton, and at least partially overlapping the plurality of end flaps to form at least one closed end of the carton.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan schematic view of a blank for forming a carton according to an exemplary embodiment of the disclosure.

FIG. 2 is a perspective view of a carton from the blank of FIG. 1 according to an exemplary embodiment of the disclosure.

FIG. 3 is a perspective cross-sectional view taken along the line 3-3 of FIG. 2.

FIG. 4 is a top plan cross-sectional view taken along the line 3-3 of FIG. 2.

FIG. 5 is a perspective view of an open configuration of the carton of FIG. 2 according to an exemplary embodiment of the disclosure.

FIG. 6 is a plan view of another open configuration of the carton of FIG. 2 according to an exemplary embodiment of the disclosure.

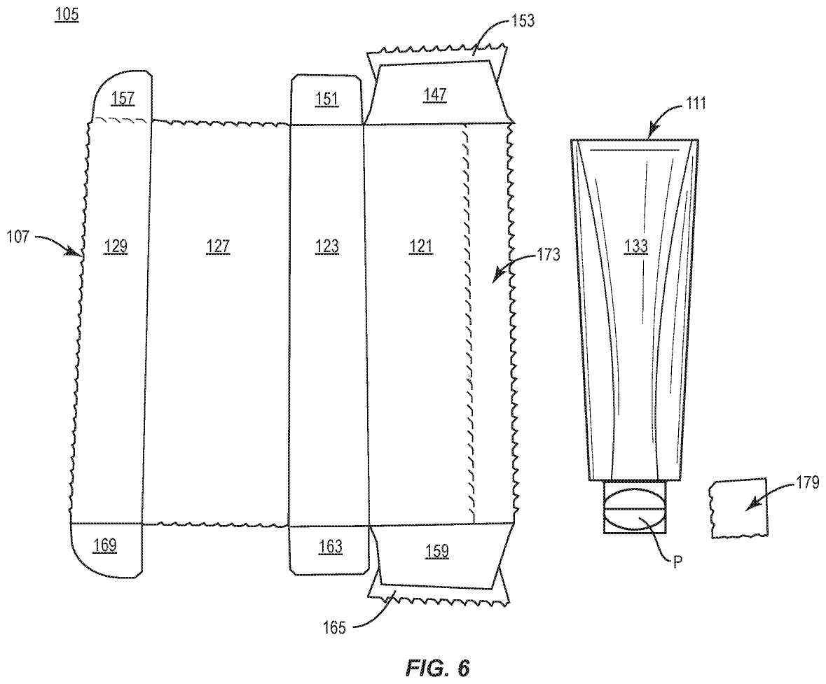

Corresponding parts are designated by corresponding reference numbers throughout the drawings.

### DETAILED DESCRIPTION OF THE EXEMPLARY EMBODIMENTS

The present disclosure generally relates to constructs, cartons, carriers, clips, sleeves, or the like, and packages for shipping and dispensing articles such as containers, cartons, constructs, sleeves, etc. that hold one or more articles such as personal care items (e.g., soaps, lotions, cosmetics, medicinal products, toothpaste rinses such as mouthwash, etc.), household products (e.g., soap, hand or surface sanitizer, etc.), food products, or other articles. As described herein, such articles can be provided within a dedicated packaging, or the cartons described herein can be configured to directly hold the material associated with such products.

Cartons according to the present disclosure can accommodate articles of any shape. For the purpose of illustration and not for the purpose of limiting the scope of the disclosure, the following detailed description describes product holding containers (e.g., paperboard cartons having closed ends) as associated with the shipping and dispensing construct embodiments and/ or as disposed within the construct embodiments. In this specification, the terms “inner,” “interior,” “outer,” “exterior,” “lower,” “bottom,” “upper,” and “top” indicate orientations determined in relation to fully erected and upright constructs and cartons.

As described herein, cartons may be formed by multiple overlapping panels, end flaps, and/or other portions of blanks. Such panels, end flaps, and/or other portions of the blank can be designated in relative terms to one another, e.g., “first”, “second”, “third”, etc., in sequential or non-sequential reference, without departing from the disclosure.

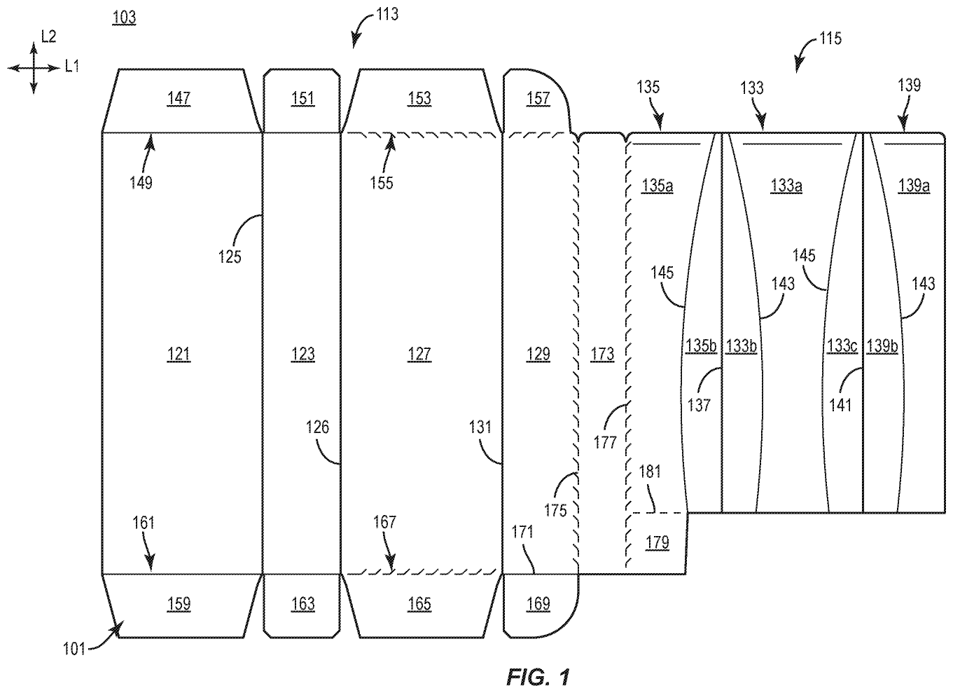

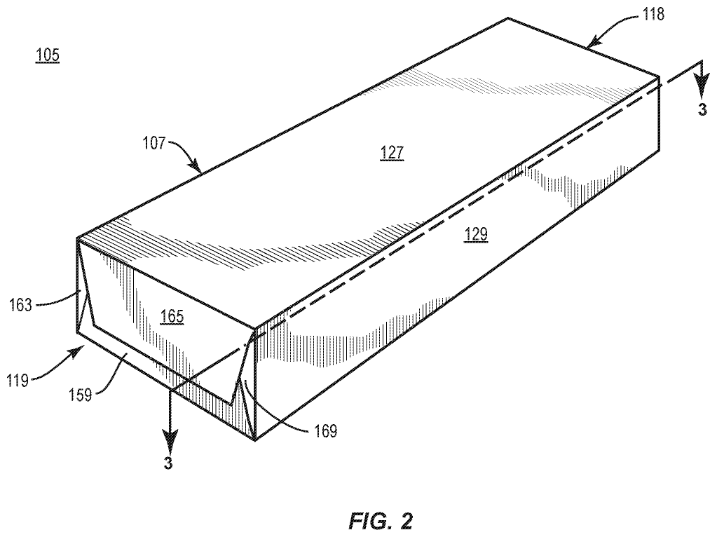

FIG. 1 is a plan view of an exterior surface 101 of a blank 103 used to form a carton (FIG. 2) according to an exemplary embodiment of the present disclosure. The carton 105 can have an outer portion 107 that defines an interior 109 within which an article retention portion 111 is positioned for holding one or more articles. In embodiments, the carton 105 can include one or more separating and/or dispensing features for accessing one or more articles held in the carton 105.

As shown, the blank 103 has a longitudinal axis L2 and a lateral axis L2. The blank 103 includes an outer portion or first portion 113 for forming the outer portion 107 of the carton 105, and the blank 103 includes an article retention portion or second portion 115 for forming the article retention portion 111 of the carton 105. In the illustrated embodiment, the first portion 113 of the blank 103 is separably connected to the second portion 115 of the blank 103 such that when the carton 105 is formed from the blank 103, the article retention portion 111 is separable from the outer portion 107, as described further herein.

The blank 103 includes a plurality of panels for extending at least partially around the interior 109 of the carton 105 formed from the blank 103. The first portion 113 of the blank 103 can include a first plurality of panels for extending at least partially around the interior 109 of the outer portion 107 of the carton 105, which can be a first interior of the carton 105. The second portion 115 of the blank 103 can include a second plurality of panels for extending at least partially around an interior 117 of the article retention portion 111 of the carton 105, which can be a second interior of the carton 105.

In the illustrated embodiment, the first portion 113 of the blank 103 can include a back panel 121 foldably connected to a first side panel 123 (broadly, “second side panel”) at a lateral fold line 125, a front panel 127 foldably connected to the side panel 123 at a lateral fold line 126, and a second side panel 129 (broadly, “first side panel”) foldably connected to the front panel 127 at a lateral fold line 131.

The second portion 115 of the blank 103 can include a front panel 133 foldably connected to a first back flap or first back panel 135 at a lateral fold line 137, and a second back flap or second back panel 139 foldably connected to the front panel 133 at a lateral fold line 141.

A pair of curved fold lines 143, 145 extend from a lateral free edge of the front panel 133 to an opposite lateral free edge of the front panel 133, with the fold line 143 generally curving toward the fold line 137, and with the fold line 145 curving generally toward the fold line 141. As also shown, the first back panel 135 can include a curved fold line 145 and the second back panel 139 can include a curved fold line 143.

In this regard, the respective fold lines 143, 145 can at least partially partition the panel 133 into a central section 133a, a first outer section 133b at least partially foldably connected to the central section 133a at the respective fold line 143, and a second outer section 133c at least partially foldably connected to the central section 133a at the respective fold line 145.

The respective fold line 145 can at least partially bifurcate the panel 135 into a first section 135a and a second section 135b at least partially foldably connected at the respective fold line 145. Similarly, the respective fold line 143 can at least partially bifurcate the panel 139 into a first section 139a at least partially foldably connected to a second section 139b at the respective fold line 143. The second portion 115 of the blank 103 can have a different configuration and/or arrangement without departing from the disclosure.

As also shown, one or more of the panels 133, 135, 139 can include one or more additional lines of weakening, e.g., generally longitudinal lines of weakening, to facilitate formation of the article retention portion 111 of the carton 105.

The blank 103 can also include a plurality of end flaps foldably connected to a respective panel of the plurality of panels for forming at least one closed end of the carton 105 formed form the blank 103. The plurality of end flaps can include a top end flap 147 foldably connected to the back panel 121 at a respective portion of a longitudinal fold line 149 and a top end flap 151 foldably connected to the side panel 123 at a respective portion of the fold line 149. A top end flap 153 can be separably connected to the front panel 127 at a respective portion of a longitudinal tear line 155 that intersects an endpoint of the fold line 149, and a top end flap 157 can be separably connected to the side panel 129 at a respective portion of the tear line 155.

Similarly, the plurality of end flaps can include a bottom end flap 159 foldably connected to the back panel 121 at a respective portion of a longitudinal fold line 161 and a bottom end flap 163 foldably connected to the side panel 123 at a respective portion of the fold line 161. A bottom end flap 165 can be separably connected to the front panel 127 at a respective portion of a longitudinal tear line 167 that intersects an endpoint of the fold line 161, and a bottom end flap 169 can be foldably connected to the side panel 129 at a longitudinal fold line 171 that intersects an endpoint of the tear line 167.

In this regard, the top end flaps 147, 151, 153, 157 can be positioned extending along a first marginal portion of the blank 103 and the bottom end flaps 159, 163, 165, 169 can be positioned extending along a second, opposite marginal portion of the blank 103.

With continued reference to FIG. 1, the blank 103 and carton 105 formed therefrom can include separation features for at least partially separating the first portion of the blank 113/outer portion 107 of the carton 105 and the second portion 115 of the blank 103/article retention portion 111 of the carton 105. The separation features can include a tear strip 173 separably connected to the side panel 129 at a lateral tear line 175 and separably connected to the first back panel 135 at a lateral tear line 177. As also shown, a tab 179 can be separable from the tear strip 173 at a portion of the tear line 177 and from the first back panel 135 at a longitudinal tear line 181 that intersects the tear line 177.

In one embodiment, the tear strip 173 can be considered a part of the first portion 113 of the blank 103/outer portion 107 of the carton 105 such that the first portion 113 of the blank 103/outer portion 107 of the carton 105 is separable from the second portion 115 of the blank 103/article retention portion 111 of the carton 105 at the tear line 177. In another embodiment, the tear strip 173 can be considered a part of the second portion 115 of the blank 103/article retention portion 111 of the carton 105 such that the first portion 113 of the blank 103/outer portion 107 of the carton 105 is separable from the second portion 115 of the blank 103/article retention portion 111 of the carton 105 at the tear line 175. In some embodiments, the tear strip 173 can be considered a portion of the blank 103/carton 105 independent of the first portion 113/outer portion 107 and the second portion 115/article retention portion 111.

It will be understood that one or more of the end flaps 153, 157, 165 and associated lines of weakening can form part of the separation features of the blank 103/carton 105 without departing from the disclosure.

With additional reference to FIG. 2-4, according to one exemplary embodiment of the disclosure, the carton 105 can be formed from the blank 103 by inverting the blank 103 on a supporting surface, e.g., such that the exterior surface 101 is supported on the surface and such that an interior surface is facing upwardly. The second back panel 139 of the second portion 115 of the blank 103 can be folded at the fold line 141 into at least partial face-to-face contact with a respective portion of the front panel 133 of the second portion of the blank 115.

Thereafter, the front panel 133 and second back panel 139 folded thereupon can be folded at the fold line 137 into at least partial face-to-face contact with a respective portion of the first back panel 135. Such folded configuration of the second portion 115 of the blank 103 can be such that upper portions of the panels 135, 133, 139 can be at least partially joined, e.g., with adhesive such as glue, to form an at least partially closed end portion 183 of the article retention portion 111.

The second side panel 129 can then be folded at the fold line 131 into at least partial face-to-face contact with a respective portion of the front panel 127, such that the tear strip 173 is carried into at least partial face-to-face contact with a respective portion of the front panel 127, and such that the aforementioned folded configuration of the second portion 115 of the blank 103 (e.g., with the front panel 133 exposed) is carried into at least partial face-to-face contact with respective portions of the front panel 127 and side panel 123.

The back panel 121 can be folded at the fold line 125 into at least partial face-to-face contact with respective portions of the back panels 135, 139 of the second portion 115 of the blank 103 and the tear strip 173.

The aforementioned folded configuration of the blank 103 can also be considered a collapsed configuration of the carton 105, for example, for shipping and/or storage. Such configuration of the blank 103/carton 105 can be at least partially maintained with one or more applications of an adhesive such as glue.

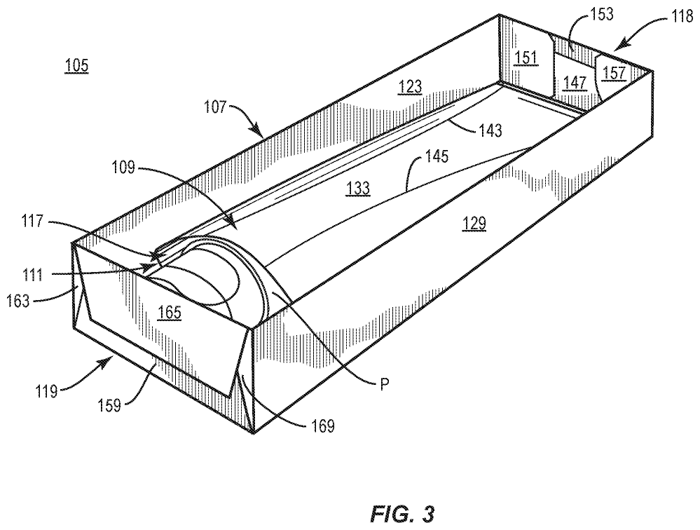

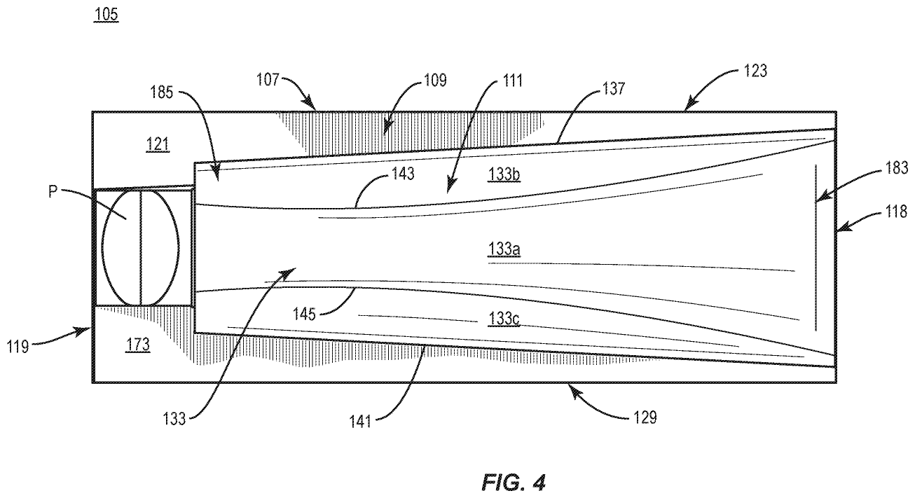

As shown in FIGS. 3 and 4, the folded configuration of the blank 103/carton 105 can be erected into an open sleeve configuration of the carton 105 by folding the plurality of panels of the blank 103/carton 105 to position the back panel 121 and the front panel 127 in generally spaced and parallel relation and to position the side panels 121, 129 in generally spaced and parallel relation. Such erection of the carton 105 can include folding the plurality of panels at one of more of the fold lines 125, 126, 131.

As shown, the panels 121, 123, 127, 129 of the outer portion 107 of the carton 105 can extend at least partially around the interior 109 in which the panels 133, 135, 139 of the article retention portion 111 are disposed. In this regard, one or more articles P can be loaded into the interior 109 of the carton 105. Specifically, one or more articles P can be loaded into the interior 117 of the article retention portion 111 of the carton 105. The interior 117 of the article retention portion 111 can be enlarged/dilated by relative movement of the panels 133, 135, 139, for example, at one or more of the fold lines 137, 141, 143, 145 such that an open end portion 185 of the article retention portion 111 of the carton 105 can have an outermost edge with a diameter that is larger than a diameter of an outermost edge of the closed end portion 183 of the article retention portion 111 of the carton 105. In some embodiments, the diameter of the closed end portion 183 of the article retention portion 111 of the carton 105 can be negligible.

In such an arrangement, the outer sections 133b, 133c of the panel 133 can be obliquely arranged relative to the central section 133a thereof, the first section 135a and the second section 135b of the panel 135b can be obliquely arranged relative to one another, and the first section 139a and the second section 139b of the panel 139 can be obliquely arranged relative to one another.

In the illustrated embodiment, the article P can be a personal care item such as a tube of toothpaste having a generally tapered or wedge-shaped body provided with a cap or other closure. It will be understood that an article P can be one or more of another personal care item (e.g., soaps, lotions, cosmetics, medicinal products, rinses such as mouthwash, etc.), household product (e.g., soap, hand or surface sanitizer, etc.), food products, or other articles.

In another embodiment, the article P can be material associated with one or more personal care items, household products, food products, or other articles as described above, without an accompanying container. For example, in some embodiments, the article P could be toothpaste provided directly into the interior 117 of the article retention portion 111 of the carton 105, e.g., such that the toothpaste is in direct contact with interior surfaces of the panels 133, 135, 139. In such embodiments, a fitment such as a nozzle, cap, and/or other closure can be provided at least partially protruding from the open end portion 185 of the article retention portion 111 to maintain disposition of the article therein and/or to facilitate dispensing of such article from the article retention portion 111.

In this regard, in one embodiment, the article P can be at least partially inserted into the interior 117 of the article retention portion 111 of the carton 105, with a portion thereof, e.g., the cap portion, protruding outwardly from lower free edges of the panels 133, 135, 139 in the interior 109 of the outer portion 107 of the carton 105.

Once one more articles P are loaded into the carton 105 as described herein, the end flaps 147, 151, 153, 157 can be at least partially folded at respective portions of the lines of weakening 149, 155 into at least partial overlapping relation to form a first closed end 118 of the carton 105. Similarly, the end flaps 159, 163, 165, 169 can be at least partially folded at respective portions of the respective lines of weakening 161, 167, 171 into at least partial overlapping relation to form a second closed end 119 of the carton 105. Such closed configuration of the carton 105 is illustrated in FIG. 2.

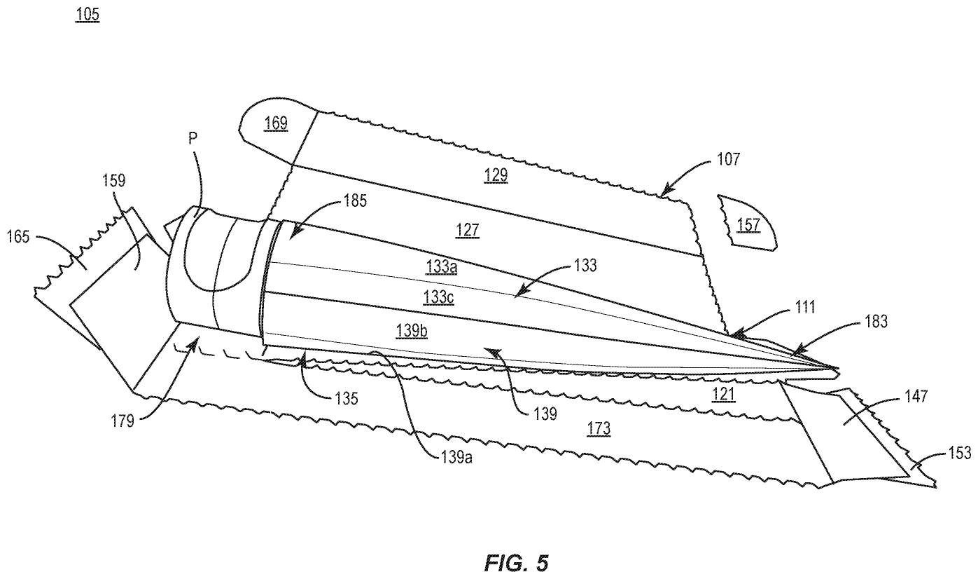

Referring additionally to FIGS. 4 and 5, when it is desired to access the one or more articles P in the carton 105, in one embodiment, a user can separate the side panel 129 from the tear strip 173 at the tear line 175 and move at least the front panel 127 and side panel 129 away from the back panel 121 to expose the article retention portion 111 in the interior 109 of the carton 105. Such separation of the side panel 129 from the tear strip 173 can include at least partially separating one or both of the top end flaps 153, 157 from the respective panels 127, 129 at respective portions of the tear line 155 in order to provide access to the tear line 175 adjacent the tear strip 173. Furthermore, such movement of the front panel 127 and the side panel 129 can include at least partially separating the front panel 127 from the end flap 165 at the tear line 167.

In the at least partially open configuration of the carton 105 illustrated in FIG. 5, the user can separate the article retention portion 111 from the outer portion 107 of the carton 105 by separating the article retention portion 111 from the tear strip 173 at the tear line 177. Such separation of the article retention portion 111 can also include at least partial separation of the back panel 135 of the article retention portion 111 from the tab 179 at the tear line 181.

In this regard, and as illustrated in FIG. 105, the article retention portion 111 can form a sleeve for the article P that is separable from the outer carton 105, e.g., to provide one or more surfaces suitable for printing or graphics that can be different or supplemental to those provided on the outer portion 107 of the carton 105.

Furthermore, the aforementioned configuration and arrangement of a carton 105 with an outer portion 107 and a separable article retention portion 111 therein can provide a uniquely shaped article retention portion 111, e.g., the at least partially tapered/wedge-shaped configuration described herein, while maintaining a symmetrical box-shaped outer portion 107 that is conducive to stacking for storage and/or transport.

Even further still, in embodiments, in which the article retention portion 111 is configured to directly received material associated with an article without an accompanying separate container, e.g., toothpaste, the carton 105 can be formed from a unitary blank of material or at least partially joined structure of a material selected to minimize materials typically associated with separate containers for materials such as toothpaste. For example, in some embodiments, the blank 103 can be comprised of paperboard so as to minimize and/or eliminate the use of polymeric materials such as plastic in providing the article retention portion 111 filled with toothpaste.

In general, the blanks of the present disclosure may be constructed from paperboard having a caliper so that it is heavier and more rigid than ordinary paper. The blank can also be constructed of other materials, such as cardboard, or any other material having properties suitable for enabling the carton to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding there along. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for holding one or more articles, the carton comprising:
an outer portion comprising a first plurality of panels extending at least partially around a first interior of the carton;
an article retention portion positioned in the first interior of the carton, the article retention portion comprising a second plurality of panels extending at least partially around a second interior of the carton for holding the one or more articles, the article retention portion separably connected to the outer portion; and
a plurality of end flaps foldably connected to a respective panel of the first plurality of panels for forming at least one closed end of the carton.

2. The carton of claim 1, wherein the article retention portion is separably connected to a tear strip.

3. The carton of claim 2, wherein the tear strip is separably connected to a respective panel of the first plurality of panels.

4. The carton of claim 3, wherein the second plurality of panels extends at least partially around a second interior of the carton, and the article retention portion is arranged to form a closed end portion and an open end portion for accessing the second interior of the carton, the second interior of the carton for at least partially receiving the one or more articles.

5. The carton of claim 4, wherein the second plurality of panels comprises a front panel and at least one back panel, the at least one back panel positioned in at least partial face-to-face contact with a respective panel of the first plurality of panels.

6. The carton of claim 5, wherein the at least one back panel of the second plurality of panels is a first back panel and the second plurality of panels further comprises a second back panel, the first back panel in at least partial face-to-face contact with the second back panel, the first back panel separably connected to the tear strip.

7. The carton of claim 6, wherein the first plurality of panels comprises a front panel, a back panel, and at least one side panel, the front panel and the back panel of the first plurality of panels in generally spaced and parallel relation.

8. The carton of claim 7, wherein the at least one side panel of the first plurality of panels is separably connected to the tear strip.

9. The carton of claim 8, wherein the at least one side panel of the first plurality of panels is a first side panel and the first plurality of panels further comprises a second side panel in generally spaced and parallel relation with the first side panel of the first plurality of panels, the first side panel of the first plurality of panels is separably connected to the tear strip.

10. The carton of claim 7, wherein at least one of the first back panel and the second back panel of the second plurality of panels is in at least partial face-to-face contact with the back panel of the first plurality of panels.

11. The carton of claim 10, wherein the plurality of end flaps comprises at least one front end flap foldably connected to the front panel of the first plurality of panels, and the plurality of end flaps comprises at least one back end flap foldably connected to the back panel of the plurality of panels, the at least one front end flap and the at least one back end flap in at least partial overlapping relation to form the at least one closed end of the outer portion of the carton.

12. The carton of claim 11, wherein the at least one front end flap is separably connected to the front panel of the first plurality of panels.

13. The carton of claim 12, wherein the at least one closed end of the outer portion of the carton is a first closed end of the carton, the at least one front end flap is a first end flap, the at least one back end flap is a first back flap, the outer portion of the carton comprises a second closed end, the plurality of end flaps comprises a second front end flap foldably connected to the front panel of the first plurality of panels and the plurality of end flaps comprises a second back end flap foldably connected to the back panel of the first plurality of panels, the second front end flap and the second back end flap in at least partial face-to-face contact to form the second closed end of the outer portion of the carton, and the second front end flap separably connected to the front panel of the first plurality of panels.

14. The carton of claim 7, further comprising a tear tab, the tear tab is separably connected to each of the tear strip and the first back panel of the second plurality of panels.

15. The carton of claim 5, wherein the front panel of the second plurality of panels comprises a plurality of sections including a central section and at least one outer section foldably connected to the central section.

16. The carton of claim 15, wherein the at least one outer section of the front panel of the second plurality of panels is a first outer section and the front panel of the second plurality of panels further comprises a second outer section foldably connected to the central section.

17. The carton of claim 16, wherein the at least one back panel comprises a first section foldably connected to a second section.

18. A blank for forming a carton for holding one or more articles, the blank comprising:
an outer portion comprising a first plurality of panels for extending at least partially around a first interior of the carton formed from the blank;
an article retention portion for being positioned in the first interior of the carton formed from the blank, the article retention portion comprising a second plurality of panels for extending at least partially around a second interior of the carton formed from the blank for holding the one or more articles, the article retention portion separably connected to the outer portion; and
a plurality of end flaps foldably connected to a respective panel of the first plurality of panels for forming at least one closed end of the carton formed from the blank.

19. The blank of claim 18, wherein the article retention portion is separably connected to a tear strip.

20. The blank of claim 19, wherein the tear strip is separably connected to a respective panel of the first plurality of panels.

21. The blank of claim 20, wherein the second plurality of panels comprises a front panel and at least one back panel, the at least one back panel for being positioned in at least partial face-to-face contact with a respective panel of the first plurality of panels when the carton is formed from the blank.

22. The blank of claim 21, wherein the at least one back panel of the second plurality of panels is a first back panel and the second plurality of panels further comprises a second back panel, the first back panel for being positioned in at least partial face-to-face contact with the second back panel when the carton is formed from the blank, the first back panel separably connected to the tear strip.

23. The blank of claim 22, wherein the first plurality of panels comprises a front panel, a back panel, and at least one side panel, the front panel and the back panel of the first plurality of panels for being positioned in generally spaced and parallel relation when the carton is formed from the blank.

24. The blank of claim 23, wherein the at least one side panel of the first plurality of panels is separably connected to the tear strip.

25. The blank of claim 24, wherein the at least one side panel of the first plurality of panels is a first side panel and the first plurality of panels further comprises a second side panel for being positioned in generally spaced and parallel relation with the first side panel of the first plurality of panels when the carton is formed from the blank, the first side panel of the first plurality of panels is separably connected to the tear strip.

26. The blank of claim 25, wherein the plurality of end flaps comprises at least one front end flap foldably connected to the front panel of the first plurality of panels, and the plurality of end flaps comprises at least one back end flap foldably connected to the back panel of the plurality of panels, the at least one front end flap and the at least one back end flap for being positioned in at least partial overlapping relation to form the at least one closed end of the outer portion of the carton formed from the blank.

27. The blank of claim 26, wherein the at least one front end flap is separably connected to the front panel of the first plurality of panels.

28. The blank of claim 23, further comprising a tear tab, the tear tab is separably connected to each of the tear strip and the first back panel of the second plurality of panels.

29. The blank of claim 21, wherein the front panel of the second plurality of panels comprises a plurality of sections including a central section and at least one outer section foldably connected to the central section.

30. The blank of claim 29, wherein the at least one outer section of the front panel of the second plurality of panels is a first outer section and the front panel of the second plurality of panels further comprises a second outer section foldably connected to the central section.

31. The blank of claim 30, wherein the at least one back panel comprises a first section foldably connected to a second section.

32. A method of forming a carton for holding one or more articles, the method comprising:
obtaining a blank comprising an outer portion separably connected to an article retention portion, the outer portion comprising a first plurality of panels, the article retention portion comprising a second plurality of panels, and a plurality of end flaps foldably connected to a respective panel of the first plurality of panels;
positioning the first plurality of panels extending at least partially around a first interior of the carton to form an outer portion of the carton;
positioning the second plurality of panels extending at least partially around a second interior of the carton to form an article retention portion of the carton positioned in the first interior of the carton and separably connected to the outer portion of the carton; and
at least partially overlapping the plurality of end flaps to form at least one closed end of the carton.

33. The method of claim 32, wherein the article retention portion is separably connected to a tear strip.

34. The method of claim 33, wherein the tear strip is separably connected to a respective panel of the first plurality of panels.

35. The method of claim 34, wherein positioning the second plurality of panels comprises positioning the second plurality of panels extending at least partially around a second interior of the carton such that the article retention portion is arranged to form a closed end portion and an open end portion for accessing the second interior of the carton, the second interior of the carton for at least partially receiving the one or more articles.

36. The method of claim 35, wherein the second plurality of panels comprises a front panel and at least one back panel, and positioning the second plurality of panels comprises positioning the at least one back panel in at least partial face-to-face contact with a respective panel of the first plurality of panels.

37. The method of claim 36, wherein the at least one back panel of the second plurality of panels is a first back panel and the second plurality of panels further comprises a second back panel, the first back panel separably connected to the tear strip, and positioning the second plurality of panels comprises positioning the first back panel in at least partial face-to-face contact with the second back panel.

38. The method of claim 37, wherein the first plurality of panels comprises a front panel, a back panel, and at least one side panel, and positioning the first plurality of panels comprises positioning the front panel and the back panel of the first plurality of panels in generally spaced and parallel relation.

39. The method of claim 38, wherein the at least one side panel of the first plurality of panels is separably connected to the tear strip.

40. The method of claim 39, wherein the at least one side panel of the first plurality of panels is a first side panel and the first plurality of panels further comprises a second side panel, the first side panel of the first plurality of panels is separably connected to the tear strip, the positioning the first plurality of panels comprises positioning the fist side panel and the second side panel of the first plurality of panels in generally spaced and parallel relation.

41. The method of claim 38, wherein positioning the second plurality of panels comprises positioning at least one of the first back panel and the second back panel of the second plurality of panels in at least partial face-to-face contact with the back panel of the first plurality of panels.

42. The method of claim 41, wherein the plurality of end flaps comprises at least one front end flap foldably connected to the front panel of the first plurality of panels, and the plurality of end flaps comprises at least one back end flap foldably connected to the back panel of the plurality of panels, and the method further comprises at least partially overlapping the at least one front end flap and the at least one back end flap to form the at least one closed end of the outer portion of the carton.

43. The method of claim 42, wherein the at least one front end flap is separably connected to the front panel of the first plurality of panels.

44. The method of claim 43, wherein the at least one closed end of the outer portion of the carton is a first closed end of the carton, the at least one front end flap is a first end flap, the at least one back end flap is a first back flap, the plurality of end flaps comprises a second front end flap foldably connected to the front panel of the first plurality of panels and the plurality of end flaps comprises a second back end flap foldably connected to the back panel of the first plurality of panels, the second front end flap separably connected to the front panel of the first plurality of panels, and the at least partially overlapping the plurality of end flaps comprises at least partially overlapping the second front end flap and the second back end flap in at least partial face-to-face contact to form a second closed end of the outer portion of the carton.

45. The method of claim 38, further comprising a tear tab, the tear tab is separably connected to each of the tear strip and the first back panel of the second plurality of panels.

46. The method of claim 36, wherein the front panel of the second plurality of panels comprises a plurality of sections including a central section and at least one outer section foldably connected to the central section.

47. The method of claim 46, wherein the at least one outer section of the front panel of the second plurality of panels is a first outer section and the front panel of the second plurality of panels further comprises a second outer section foldably connected to the central section.

48. The method of claim 47, wherein the at least one back panel comprises a first section foldably connected to a second section.
